(19) United States
(12) Patent Application Publication
(10) Pub. No.: US 2015/0058653 A1
(43) Pub. Date: Feb. 26, 2015

(54) Integrated Circuit Power Measurement and Adaptation

(71) Applicant: Broadcom Corporation, Irvine, CA (US)

(72) Inventor: Ilya Blayvas, Holon (IL)

(73) Assignee: Broadcom Corporation, Irvine, CA (US)

(21) Appl. No.: 14/013,268

(22) Filed: Aug. 29, 2013

Related U.S. Application Data
(60) Provisional application No. 61/868,303, filed on Aug. 21, 2013.

(51) Int. Cl. G06F 1/26

(52) U.S. Cl. CPC G06F 1/26
USPC 713/340

(57) ABSTRACT

An integrated circuit (e.g., a system application processor IC) includes power supply lines that include a section having a known resistance. Measurement connections across the section are also present. The measurement connections may run to an Analog to Digital Converter (ADC). The ADC measures the voltage drop across the section and therefore the power consumed by the circuitry supplied by the power supply line. The power consumption by any particular circuitry in the IC may be monitored, from entire processing cores, down to single transistors. An analysis system may read the power consumption measurements and accordingly adapt the operation of the code segments in the system to meet specified power or energy consumption targets, e.g., to minimize the power and energy consumption.

### CROSS REFERENCE TO RELATED APPLICATIONS

This application claims priority to provisional application Ser. No. 61/868,303, filed Aug. 21, 2013, which is incorporated by reference in its entirety.

### TECHNICAL FIELD

This disclosure relates to power measurement for integrated circuits. This disclosure also relates to adaptation of circuitry responsive to power measurements.

### BACKGROUND

Rapid advances in electronics and communication technologies, driven by immense customer demand, have resulted in the widespread adoption of an extremely broad array of electronic devices in every aspect of society. Further, the continuing exponential downscaling of lithography resolutions has also resulted in exponential increases in processing power. This has resulted in new challenges in the digital signal processing industry. Where traditionally the race was for increased processing power, today the concern is power consumption and heat dissipation which set limits on modern digital integrated circuits. The explosive growth of portable battery-powered devices has also made reduced power consumption a specific design goal, in part because it is readily possible to provide much more processing power in any device than the limited energy source in the device can supply for a useful amount of time. Accordingly, the power consumption profile of integrated circuits is a particular aspect of the design of the integrated circuit.

### BRIEF DESCRIPTION OF THE DRAWINGS

FIG. 1 shows an example architecture that includes an integrated circuit (IC) and analysis system.

FIG. 2 shows an example integrated circuit with enhanced power measurement capability.

FIG. 3 shows an example of a measurement and analysis system.

FIG. 4 shows logic that a measurement and analysis system may implement.

### DETAILED DESCRIPTION

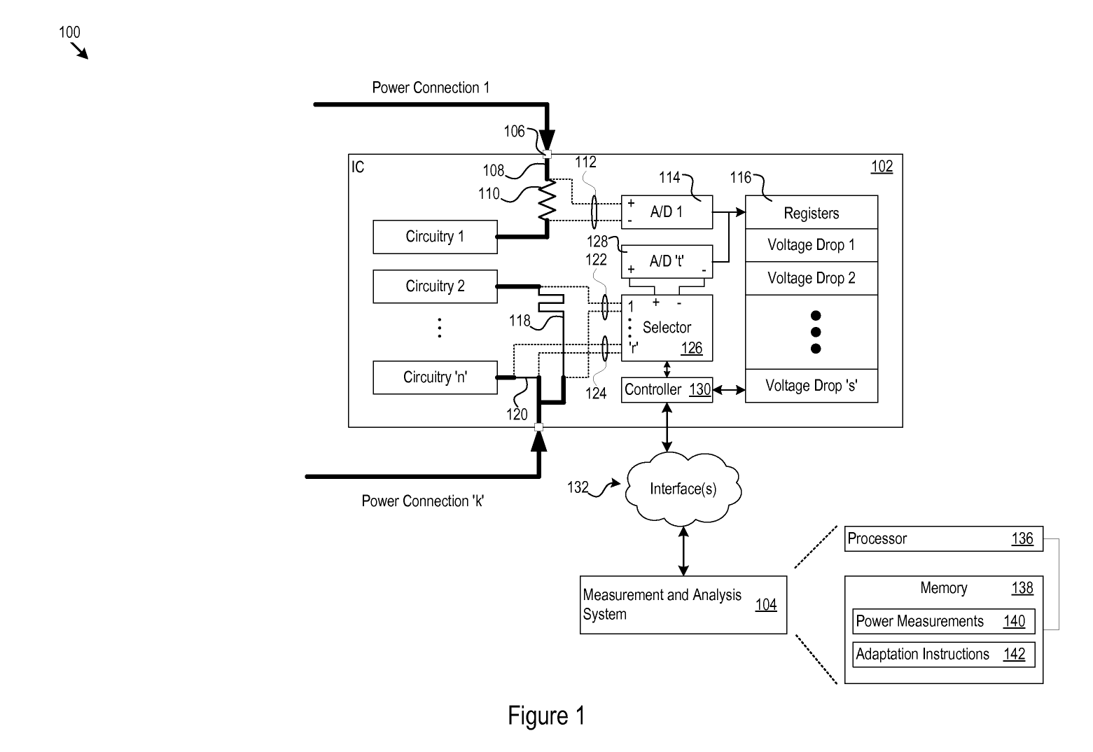

FIG. 1 shows an example architecture 100 that includes an integrated circuit (IC) 102 and analysis system 104. The IC 102 may be any type of IC, including an Application Specific IC (ASIC), System on a Chip (SoC), Field Programmable Gate Array (FPGA), Programmable Logic Device (PLD), analog (e.g., amplifier or filter), digital (e.g. logic gates or registers), or mixed signal IC, a multiple processor core processing unit, or any other type of IC. The IC 102 includes any number, ‘n’, of circuit blocks, such as the circuit block 1, circuit block 2, through circuit block ‘n’. A circuit block may include any specific circuitry to which power is delivered. Examples of circuit blocks include: processor cores, memories, registers, Arithmetic Logic Units (ALUs), multipliers, dividers, Boolean logic circuits, amplifiers, transistors, resistors, capacitors, and inductors individually or connected in larger circuits. Additional examples of circuit blocks include filters, shift registers, graphics processing units (GPU), shaders, floating point processing units, integer processing units, cache memories, texture units, controllers, vector instruction units, scalar instruction units, video memory buffers, and input/output controllers, such as serial, parallel, WiFi, Ethernet, optical, or other controllers.

The IC 102 may include any number, ‘k’, of power connections received on input pins, pads (e.g., the pad 106), balls or other connectors. Two power connections are shown in FIG. 1: power connection 1 and power connection ‘k’. Power connection 1 provides power to circuit block 1, while power connection ‘k’ provides power to circuit blocks 2 through ‘n’. In the IC 102, a power supply line 108 carries power from the power connection 1 to the circuit block 1.

The power supply line 108 includes a first specified resistance section 110 (“section 110”) formed along the power supply line 108. The section 110 may have a specific resistance per unit length, for example, under a specific semiconductor fabrication process. The section 110 may be a narrowed section of metal, polysilicon, or other conductive medium. Although drawn in FIG. 1 for the purposes of illustration with a resistor symbol, the section 110 may take any shape and run along any course that imparts a specific resistance to the section 110. Accordingly, when current flows through the section 110, a measurable voltage drop appears across the section 110.

A measurement connection 112 is located across the section 110. Accordingly, the voltage drop may be measured using the measurement connection 112. For example, the analog to digital converter (ADC) 114 may measure the voltage drop and output a representation, such as a multiple digital bit representation, of the voltage drop. The IC 102 may include any number of registers (or other type of memory, such as SRAM/DRAM) 116 that store the representation of the voltage drop across the section 110 or any other resistance section located anywhere in the IC 102. Furthermore, the registers 116 may store multiple measurements of any particular voltage drop at any interval over time. Accordingly, the registers 116 may store a history of the voltage drops at any specified resistance section.

Note that, given the voltage measurement, a controller or other logic (such as the analysis instructions 320 described below) may also determine a power measurement. For example, given a voltage drop of V_{d} across the section 110 of resistance R, the current flowing through the section 110 is I=V_{d}/R, and the power delivered by the power connection to the circuit block is Vₚ*I, where Vₚ is the voltage of the power connection. As a specific example, if Vₚ=1.8 V, R=0.1 ohm, and V_{d}=20 mV, then I=200 ma, then the power consumed by the circuit block is 0.36 W.

There may be any number of circuit blocks in the IC 102. Any circuit blocks may include a power line with a specified resistance section. Additional examples include the specified resistance section 118 for the circuit block 2 and the specified resistance section 120 for the circuit block ‘n’. The resistance section 118 also includes a measurement connection 122 across the resistance section 118, and the resistance section 120 includes a measurement connection 124 across the resistance section 120.

The measurement connections 122 and 124 may be in communication with a selector 126. The selector 126 selectively connects a measurement connection to the ADC 128 from among ‘r’ inputs to the selector 126. The selector 126 may be an analog multiplexer or other device operable to pass an analog voltage through to the ADC 128. The ADC 128 may be separate from the ADC 114, and there may be any number ‘t’ of ADCs in the IC. Any ADC in the IC 102 may measure the voltage drops across the resistance sections. The ADCs may be ADCs already present in the IC 102 for other purposes, and may therefore be connected to any of the circuit blocks for any particular analog to digital conversion task. Alternatively, any of the ADCs may be provided in the IC 102 for the specific purpose of measuring the voltage drops across the resistance sections.

The controller 130 may be configured in hardware or software/firmware to control the selector 126 according to any programmed schedule of voltage drop measurements. Further, the controller 130 may be configured to read or write voltage drop measurements from the registers 116. In that regard, the controller 130 may communicate any of the voltage drop measurements to the analysis system 104. The communication may take place locally or remotely across any interface 132, including any network, or interconnection of networks.

The analysis system 104 may include a processor 136 and a memory 138. The memory stores power measurements 140, which may include the voltage drop measurements, the resistance values of the resistance sections, and corresponding currents, and the power delivered to any circuit block. The power measurements 140 may be obtained at any desired point in time, any may include a history of power measurements taken at any interval over any time window, for any resistance section in the IC 102.

The memory also includes adaptation instructions 142. The adaptation instructions 142 may, when executed, analyze the power measurements 140 and determine an adaptation to any specific circuit block. In other words, the adaptation may change the execution behavior of the IC 102 in response to power consumption within the IC 102. The processor 136 executes the adaptation instructions 142.

One example of an adaptation is a code optimization. The code optimization may, for example, change the instructions in a code segment that compute certain results, such as by replacing division opcodes with less power consuming subtract and bit shift operations. As another example, the adaptation may be a processing core assignment for a code segment. For example, the processing core assignment may direct specific code segments for execution by a specific processing core. Additional examples of adaptations include compiler modifications (e.g., setting different compiler flags) that change the behavior of a compiler that compiles code executed by the circuit blocks, and a code selection that determines which code segment from among multiple options for different code segments is executed by the circuit blocks.

Expressed another way, measuring the power consumption of the different circuit blocks of the IC 102 facilitates several strategies and solutions for reducing power consumption. The code developer at the development stage may make a profile of power consumption of the algorithm under design. The profile may include profiling at the granularity of any code segment, e.g., at the task/core level, at the algorithm level, at the function level, or even at the individual instruction level. The code profiling will facilitate developer optimization, in terms of power consumption, of the algorithms in the code that the developer is designing. The optimization may take into consideration many different aspects, as just a few examples: being aware of the power consumption of different algorithms, the developer may choose the code segments that consume the least power; the developer may optimize specific code segments to further reach a power consumption goal (e.g., by replacing power expensive instructions with reduced power variations of the instructions); and the developer may chose a particular processing core on which to execute a code segment, such as a processing core that minimizes energy consumption for executing the code segment and completing any given set of computational tasks.

In many cases it is possible to execute the same code segment using different circuit blocks, such as processing units or processing cores of the IC 102. While it is possible to make allocations of code segments to processing cores according to processing speed, those allocations may result in high power consumption. For example, it may be the case that for particular code segment, processing core A is 2 times faster than processing core B, yet processing core B consumes 3 times less power than processing core A, making the total energy for processing on processing core B 1.5 times lower than the total energy for processing on processing core A. In that case the adaptation may be to choose to execute the code segment on processing core B to save power and energy consumption.

Additionally, in many cases, the same problem or task can be solved with different algorithmic solutions. While it is possible to make a decision of solution solely based on the fastest algorithm, it might be the case that between algorithms A and B, algorithm A is preferable in terms of execution speed, and algorithm B is preferable in terms of power consumption. Having the analysis system 104 monitor and measure the power consumption during the execution of different algorithmic solutions facilitates providing adaptations to the developer to optimize the selection of code in terms of power consumption to find the algorithmic solution that provides reduces power consumption.

Further adaptations include compilation options. Modern compilers often have optimization options, for example. The optimization options adapt the compiler to generate different code according to execution speed, memory consumption, or other criteria. In one implementation, the analysis system 104 measures the energy consumption for each opcode of an assembly language code segment. The opcode energy measurements facilitate adapting the compiler to generate code segments that are more energy efficient. The adaptation may then be to set a compiler flag to optimize (e.g., reduce or minimize) energy consumption by replacing energy expensive instructions or code segments with less energy expensive instructions or code segments.

As a further example of optimization, the same code segment may be compiled for different computing units of different processing architectures. While executing that code segment with the different processing units, an operating system may will learn which of the computing units is the most efficient in terms of power consumption. The operating system may then direct future execution of that code segment to the processing units that reduce the energy consumption. The OS may run in the IC 102, may run in the analysis system 104, or may run at another level within a system that includes the IC 102.

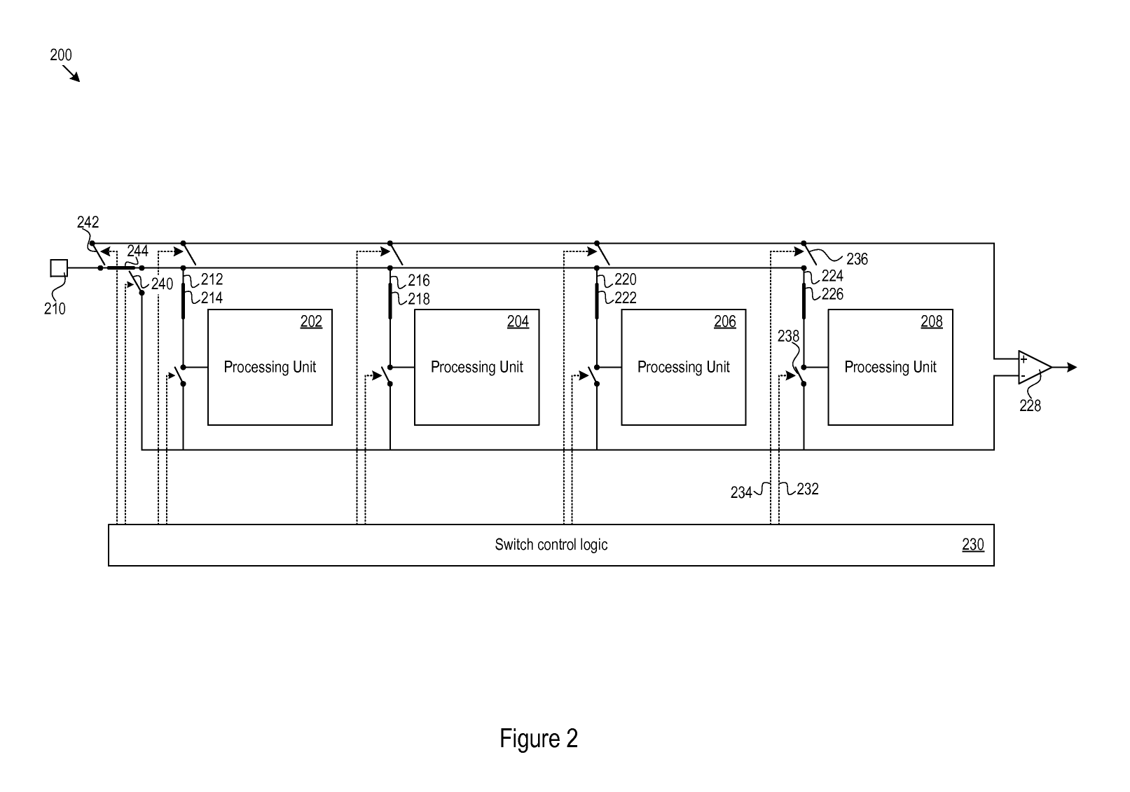

FIG. 2 shows an example IC 200 with enhanced power measurement capability. In this example, the IC 200 is system including different processing units, specifically the units 202, 204, 206, and 208. The processing units may be different types of circuit blocks, such as memories, individual transistors, ALUs, DSP function blocks, processing cores, or any other circuitry. That is, the processing units may be any circuit block of arbitrary complexity, including an entire system, subsystem, processing core, single multiplier or divider, discrete circuit component (e.g., a transistor), or any other circuit block. Each processing unit receives power from a power connection made to the input pad 210. The power line 212 leading to processing unit 202 includes a specified resistance section 214. The processing units 204, 206, and 208 similarly have power lines 216, 220, and 224 that include specified resistance sections 218, 222, and 226 respectively.

An ADC 228 selectively converts the voltage drop across any selected resistance section to a digital representation. In that respect, the switch control logic 230 (e.g., a programmed controller), may selectively open and close switches to connect the selected specified resistance section to the ADC 228. In FIG. 2, for example, the switch control logic 230 may assert switch control signals 232 and 234 to close switches 236 and 238 respectively. When switches 236 and 238 are closed, the voltage drop across the specified resistance section 226 is connected to the ADC 228. The ADC 228 output a digital representation of the voltage drop which is stored in a register or other memory for later analysis.

The switch control logic 230 may individually open and close any of the switches shown in FIG. 2 to obtain any specific voltage drop measurement for any of the processing units 202-208. Further, the switch control logic 230 may close the switches 240 and 242 to obtain a voltage drop measurement along the specified resistance section 244. The specified resistance section 244 generates a voltage drop responsive to current flowing to all four processing units. Not every processing unit needs to have a power line with a specified resistance section or switches to couple the specified resistance section to the ADC 228. Instead, specified resistance sections may be selectively included in the circuit design for those circuit blocks for which power measurement is desired.

The switches may be implemented in many different ways. As one example, the switches may be individual Metal Oxide Semiconductor (MOS) transistors. Specifically, the switch control logic 230 may control the gate voltage of a MOS transistor to place it in a conductive state (switch closed) or non-conductive (switch open) state.

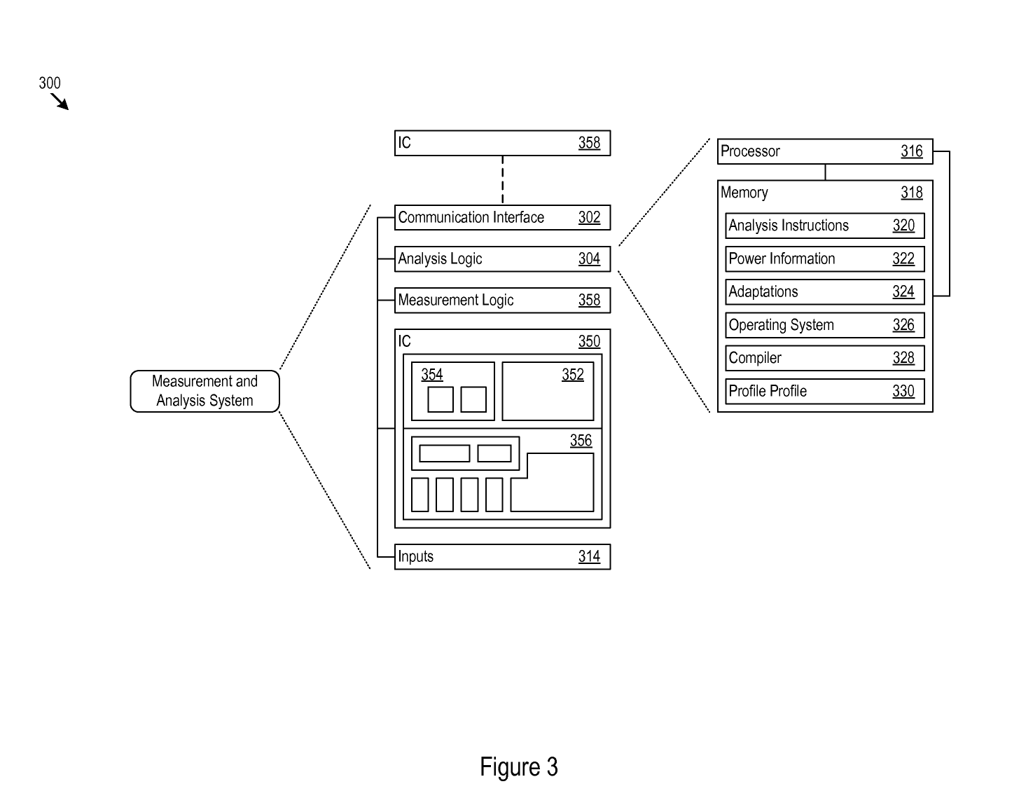

FIG. 3 shows an example measurement and analysis system 300 (“system 300”). The system 300 operates on the IC 350. The IC 350 may have any number of circuit blocks of any complexity, such as the circuit blocks 352, 354, and 356. Any of the circuit blocks may be in turn divided into units of finer granularity, such as processing cores, subcores, processing units, ALUs, registers, and the like. A measurement logic 358 measures the power associated with the IC 350 at any desired level, such as at the system level, subsystem level, processing core or finer granularity level. In that regard, the measurement system 358 may include any number of ADCs and measurement connections. The measurement system 358 may obtain voltage drop measurements simultaneously or sequentially from one or more circuit blocks in the IC 350. To do so, the measurement system 358 may operate as explained above in FIGS. 1 and 2 to choose the particular voltage drops and connect the associated measurement connections to an available ADC. The ADCs may be connected to memories, e.g., registers, in which the ADC measurement outputs are stored. The analysis logic 304 may read the measurements over the same address and data busses, or different address and data busses used by the measurement system 358.

The number, ‘t’, of ADCs in the measurement logic 358 may determine the number of simultaneous voltage drop measurements. The number, ‘c’ of measurement connections may determine the number of different measurement locations. In the measurement logic 358, the ADCs measure the voltage drops at any speed supported by the ADCs. For instance, the ADCs may have an integration time between 1 nanosecond and 1 microsecond. Shorter and longer integration times are also possible.

In order to ascertain the energy consumed to determine any result, the measurement logic 358 may measure the voltage drops during the processing done by the circuit blocks. As just one example, during a 600 ms execution of a code segment that implements a digital filter, the measurement logic 358 may obtain voltage drop measurements every 100 nanoseconds at each circuit block involved in the digital filter calculations.

The analysis logic 304 reads the voltage drop measurements from the registers maintained, e.g., by the measurement logic 358. The analysis logic 304 may then determine the power consumed from the voltage drops, resistances, and voltage supplied, and determine total energy consumed at each circuit block as the integration of power over time. In that regard, the analysis logic 304 may read predefined data that gives the resistivity and voltage of corresponding power lines, calculate the power consumption, and integrate the power consumption values over time. The analysis logic 304 may thereby determine energy consumption at any level of circuit granularity associated with the measurement connections, and at any level of granularity in the code segment (e.g., per instruction or per procedure or task), and may store power and energy consumption data for further processing and analysis.

The power and energy consumption data can be used in multiple ways. As one example, the data may be used during the development phase. Having the measurement of the power/energy budget of each command, procedure, and task allows the developer to optimize the code segment in terms of power consumption. Because modern software development is virtually blind in terms of power consumption this additional information may provide breakthrough advantages in power saving, such as by reducing power consumption by tens of percent or even by a factor of two or more.

As another example, the data may be used during hardware development. Knowing the power profiling per task and per circuit block assists the hardware developer in making design choices leading to more power efficient system configurations. That is, the hardware designer need not rely on approximate power consumption guess-work during the hardware design phase.

Still further, the data may be used for software architecture development. For instance, the software developer may make informed choices and decisions concerning which hardware core to execute each code segment. Thus, instead of making guesses on gut instinct, the system 300 provides accurate measurements for making informed decisions.

As yet another example, the data may be used in connection with compilation of source code. The system 300 provides a mechanism for profiling the power and energy used even down to the level of a single opcode. As a result, the system 300 may use this power and energy information to adapt compiler behavior, for example by providing the power and energy information to a compiler that in response applies compilation options that generate power-optimized executable code segments.

Note also that the data may be used during the operation of the device. For instance, the operating system may obtain measurements of the power and energy budget for running various tasks on various processing cores in the system. Using that information, the operating system may make informed decisions about which processing core to use to execute each task in order to minimize power or energy consumption.

Alternatively or additionally, the system 300 may be an external system connected to an IC 358 via a local or remote communication bus to the communication interface 302, such as a serial bus, parallel bus, or wired or wireless network connection. In that respect, the system 300 may obtain and analyze voltage drop data from any IC that supports voltage drop measurements. The communication interface 302 may include one or more Ethernet ports, or any other type of wired or wireless communication interface. The communication interface 302 may receive power information from any device 358 that has measured voltage drops across specified resistance sections, such as the IC 102 and the IC 200. The power information may include any combination of: voltage drop measurements, current determinations, voltage supply measurements, resistance information, or any other information that has a bearing on power consumption.

The analysis logic 304 may be implemented in hardware, software, or both. In one implementation, the analysis logic 304 includes one or more processors 316 and memories 318. The memory 318 may store analysis instructions 320 (e.g., program instructions) for execution by the processor 316. The memory 318 may also hold the power information 322 received at the communication interface 302.

As described above, the analysis instructions 320 may generate adaptations 324. The analysis system 104 may send the adaptations to a user interface for, e.g., the code developer to view, to an operating system (OS) 326, to a compiler 328, back to the IC 358, or to any other destination. Many examples of adaptations 324 were given above, including changes to compiler options, selection of code segments, and assignment of code segments to specific circuit blocks in the device 350. Any of the power information may be obtained at any desired interval responsive to any desired operating conditions (e.g., according to a particular code segment running in a particular circuit block), retained over any desired time span, and organized into a power profile 330 for any circuit block in the ICs. The power profile 330 may thereby capture power and energy consumption at any level of granularity in a code segment, and tag the measured code segment with its power and energy consumption at any given time, or over any interval of time.

The analysis system helps to understand, in detail and at very granular levels, the power consumption of specific circuit blocks in an IC. As just a few examples, the system 300 may generate user interfaces that display time series traces of per-device power consumption or per-circuit block power consumption. The traces may be specific to particular code segments or other operating conditions. When thermal measurements are available, the user interfaces may also show a thermal map across the device, which may help determine to which circuit blocks code segments or other processing tasks may be allocated to balance thermal stress, thereby helping to control energy dissipation at a certain targeted area of the IC.

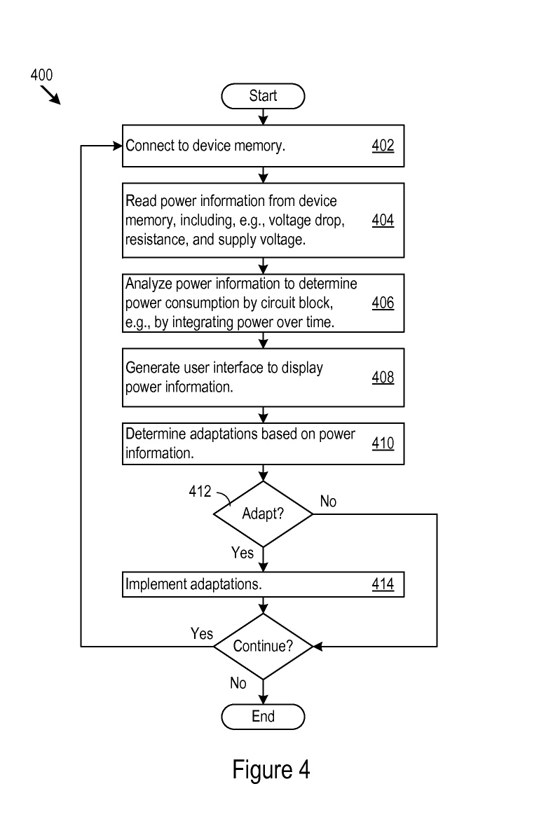

FIG. 4 shows logic 400 that an analysis system may implement, for example, as the analysis instructions 320. The logic 400 connects to a device memory (402). For example, the analysis system 104 may connect to the device 350 and read power information stored in the memory (e.g., the power information registers) of the device (404). The analysis system 104 may then analyze the power information to determine, for example, power consumption by circuit block (406).

The logic 400 also generates a GUI 310, on which the logic 400 may display power information (408). The logic 400 determines adaptations based on power information (410). The adaptations may be received as operator input in response to the GUI 310 display, as one example. As discussed above, the logic 400 may also determine adaptations based on the power information by determining whether compiler optimizations are available, whether alternate code segments are available, or whether code segments may be mapped to different circuit blocks in a device, as just a few examples. For instance, if the power information shows that a particular processing core is expending too much total energy or consumes too much power to execute a particular code segment that implements a filtering algorithm, then the logic 400 may suggest as an adaptation a different code segment that also implements the filtering algorithm, at a lower total energy consumption or using less power.

The logic 400 determines whether adaptations are available and whether an adaptation should be made (412). When the logic 400 decides to make the adaptation, then the logic 400 may implement the adaptation (414). For instance, the logic may reassign a code segment to a different circuit block, may select a different code segment to run on a particular circuit block, or may set a compiler flag for the compiler 328 that causes the compiler 328 to consider total energy consumption or power consumption during the compilation of source code. As a result, the compiler 328 may generate code that consumes less total energy to achieve a goal, or that consumes less power and therefore generates less thermal stress in the IC.

When the adaptation is an assignment of code segment to a circuitry block, an operating system may responsively load the specific code segments for execution on the assigned circuitry blocks. The assignments may help to meet a power consumption goal, such as to reduce or minimize power or energy consumption. The system 300 may allow the code segments to operate on different circuit blocks and obtain power measurement data for each execution. As explained above, the system 300 may integrate the power over time to determine energy consumption.

The system 300 facilitates a software development approach informed by energy and power consumption profiles. The software development approach takes into consideration the power data to make informed decisions about the structure and content of code segments. That is, the software development process is now informed by power consumption data, which may result in specific design choices for individual instructions, subroutines, modules or any other code segment to include in the ultimate code that will run on the device. In the hardware design context, the power data facilitates hardware design. For instance, the power data may drive informed decisions about choices between components and architectures so that a power goal is met, such as reducing or minimizing power consumption or energy consumption. For instance, a hardware designer may choose a specific circuit layout, transistor geometry, or processing core implementation, informed by the power consumption profile for executing processing tasks using various circuit options.

What is claimed is:

1. A system comprising:
first processing circuitry;
a first power supply line connected to the first processing circuitry, the first power supply line comprising:
a first specified resistance section formed along the first power supply line; and
a first measurement connection across the first specified resistance section;
a first analog to digital converter connected to the first measurement connection and configured to output a representation of a first voltage drop across the first specified resistance section; and
a first register operable to store the representation of the first voltage drop.

2. The system of claim 1, further comprising:
second processing circuitry;
a second power supply line connected to the second processing circuitry, the second power supply line comprising:
a second specified resistance section formed along the second power supply line; and
a second measurement connection across the second specified resistance section; and
a second register operable to store a representation of a second voltage drop across the second specified resistance section.

3. The system of claim 2, where the first analog to digital converter is also configured to output the representation of the second voltage drop.

4. The system of claim 2, further comprising a second analog to digital converter that is configured to output the representation of the second voltage drop.

5. The system of claim 1, further comprising:
a controller configured to read the representation of the first voltage drop and adapt operation of the processing circuitry responsive to the representation.

6. The system of claim 5, where the controller is further configured to:
determine a power consumption measurement from the representation of the first voltage drop.

7. The system of claim 1, where the first processing circuitry comprises a processor core.

8. The system of claim 1, where the first processing circuitry comprises a functional block within a processor core.

9. The system of claim 1, further comprising a switch configured to selectively connect the first measurement connection to the first analog to digital converter.

10. The system of claim 1, further comprising a switch configured to selectively connect a selected voltage measurement connection chosen from among multiple measurement connections including the first measurement connection, to the first analog to digital converter.

11. A system comprising:
a first circuit module;
a second circuit module;
a first power line comprising a first resistance section connected to the first circuit module;
a second power line comprising a second resistance section connected to the second circuit module;
a power measurement unit operable to:
obtain a first circuit power measurement from the first resistance section; and
obtain a second circuit power measurement from the second resistance section; and
a memory operable to store the first circuit power measurement and the second circuit power measurement.

12. The system of claim 11, where:
the power measurement unit comprises an analog to digital converter shared by at least one other circuit module in the system.

13. The system of claim 11, further comprising:
a switch operable to selectively connect the first resistance section and the second resistance section to the power measurement unit.

14. The system of claim 11, where the first circuit power measurement, the second circuit power measurement, or both, are voltage drop measurements.

15. The system of claim 11, further comprising:
a controller operable to:
obtain the first circuit power measurement;
obtain the second circuit power measurement; and
adapt operation of the first circuit module, the second circuit module, or both in response to the first circuit power measurement, the second circuit power measurement, or both.

16. A system comprising:
a memory operable to store:
power measurements associated with power line resistance sections connected to specific circuit blocks in an integrated circuit; and
adaptation instructions that, when executed, analyze the power measurements and determine an adaptation to the specific circuit blocks; and
a processor configured to execute the adaptation instructions.

17. The system of claim 16, where:
the adaptation comprises a code optimization.

18. The system of claim 16, where:
the adaptation comprises a processing core assignment for code.

19. The system of claim 16, where:
the adaptation comprises a compiler modification for compiling code executed by the circuit blocks.

20. The system of claim 16, where:
the adaptation comprises a code selection to determine which code is executed by the circuit blocks.
